(19) United States
(12) Patent Application Publication
(10) Pub. No.: US 2023/0252309 A1
(43) Pub. Date: Aug. 10, 2023

(54) BUILDING KNOWLEDGE GRAPHS BASED ON PARTIAL TOPOLOGIES FORMULATED BY USERS

(71) Applicant: International Business Machines Corporation, Armonk, NY (US)

(72) Inventors: Birgit Monika Pfitzmann, Zurich (CH); Christoph Auer, Zurich (CH); Kasper Dinkla, Zurich (CH); Michele Dolfi, Zurich (CH); Peter Willem Jan Staar, Zurich (CH)

(21) Appl. No.: 17/650,086

(22) Filed: Feb. 7, 2022

(51) Int. Cl. G06N 5/02; G06F 40/279

(52) U.S. Cl. CPC G06N 5/022; G06F 40/279

(57) ABSTRACT

A computer-implemented method, a computer program product, and a computer system for building a knowledge graph. A computer system converts user inputs as to a partial topology of a knowledge graph that a user wants to build into one or more initial nodes corresponding to respective natural language descriptions. A computer system interprets the respective natural language descriptions using natural language processing to match the one or more initial nodes against reference data. A computer system, based on matched reference data, obtains a valid topology of nodes and edges, wherein the nodes and edges are mapped onto the matched reference data. A computer system, based on the valid topology, generates a data flow linking to the matched reference data via associations of the nodes and edges and the matched reference data. A computer system builds an executable knowledge graph from the data flow.

### BACKGROUND

The present invention relates generally to building knowledge graphs, and more particularly to generating a data flow from a partial knowledge graph topology provided by a user to automatically build a knowledge graph.

A knowledge graph, also known as a semantic network, represents a network of entities (e.g., objects, events, situations, or concepts) and illustrates the relationship between such entities. A knowledge graph is a common data structure used to represent knowledge. Knowledge graphs have been fast emerging as a standard to model and explore knowledge in weakly structured data. Knowledge graphs comprise nodes (i.e., vertices) representing entities and links (i.e., edges) between the nodes, where the links represent facts or relations. This information is usually stored in a graph database and visualized as a graph structure.

For example, the so-called Corpus Processing Service (CPS) is a scalable cloud platform for creating and then serving in-memory knowledge graphs (KGs), using natural-language processing (NLP) at build time and vector manipulation at search time. Its purpose is to process large document corpora, extract the content and embedded facts, and ultimately represent these in a consistent knowledge graph that can be intuitively queried by users. CPS relies on natural language understanding models to extract entities and relationships from the documents.

In general, KGs are built according to so-called data flows. A data flow has a specific meaning in the context of KGs. It typically involve different types of tasks, such as extracting document elements (abstracts, paragraphs, tables, figures, etc.), annotating these elements to detect entities and their relationships, and aggregating these entities and their relationships. Although data flows are an abstraction of NLP code, they remain largely procedural. As a result, many users struggle to correctly formulate the data flows. Thus, there is a need for more user-friendly methods of building knowledge graphs.

### SUMMARY

In one aspect, a computer-implemented method for building a knowledge graph is provided. The method includes converting user inputs as to a partial topology of a knowledge graph that a user wants to build into one or more initial nodes corresponding to respective natural language descriptions. The method further includes interpreting the respective natural language descriptions using natural language processing to match the one or more initial nodes against reference data. The method further includes, based on matched reference data, obtaining a valid topology of nodes and edges, wherein the nodes and edges are mapped onto the matched reference data. The method further includes, based on the valid topology, generating a data flow linking to the matched reference data via associations of the nodes and edges and the matched reference data. The method further includes building an executable knowledge graph from the data flow.

In yet another aspect, a computer system for building a knowledge graph is provided. The computer system comprises one or more processors, one or more computer readable tangible storage devices, and program instructions stored on at least one of the one or more computer readable tangible storage devices for execution by at least one of the one or more processors. The program instructions are executable to: convert user inputs as to a partial topology of a knowledge graph that a user wants to build into one or more initial nodes corresponding to respective natural language descriptions; interpret the respective natural language descriptions using natural language processing to match the one or more initial nodes against reference data; based on matched reference data, obtain a valid topology of nodes and edges, wherein the nodes and edges are mapped onto the matched reference data; based on the valid topology, generate a data flow linking to the matched reference data via associations of the nodes and edges and the matched reference data; and build an executable knowledge graph from the data flow.

In another aspect, a computer program product for building a knowledge graph is provided. The computer program product comprises a computer readable storage medium having program instructions embodied therewith, and the program instructions are executable by one or more processors. The program instructions are executable to convert user inputs as to a partial topology of a knowledge graph that a user wants to build into one or more initial nodes corresponding to respective natural language descriptions. The program instructions are further executable to interpret the respective natural language descriptions using natural language processing to match the one or more initial nodes against reference data. The program instructions are further executable to, based on matched reference data, obtain a valid topology of nodes and edges, wherein the nodes and edges are mapped onto the matched reference data. The program instructions are further executable to, based on the valid topology, generate a data flow linking to the matched reference data via associations of the nodes and edges and the matched reference data. The program instructions are further executable to build an executable knowledge graph from the data flow.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIG. 1 schematically depicts a user interacting with a computerized system (a cloud computing system) to build a knowledge graph, in accordance with one embodiment of the present invention.

FIG. 2 schematically represents a general purpose computerized system, suited for implementing one or more method steps, in accordance with one embodiment of the present invention.

FIG. 3 is a block diagram schematically illustrating modules of a system for building knowledge graphs, in accordance with one embodiment of the present invention.

FIG. 4 and FIG. 5 are flowcharts illustrating high-level steps of a method of building a knowledge graph, in accordance with one embodiment of the present invention.

FIG. 6A shows an example of a partial topology of a knowledge graph provided as a handwritten document by a user, in accordance with one embodiment of the present invention.

FIG. 6B shows an example of a valid topology, once automatically completed thanks to a method, in accordance with one embodiment of the present invention.

FIG. 7 schematically depicts a graphical user interface for assisting a user in formulating a partial topology of a knowledge graph, in accordance with one embodiment of the present invention.

FIG. 8 shows a partial outline of an example of dependency structure of tasks of a data flow obtained from a valid topology, in accordance with one embodiment of the present invention.

The accompanying drawings show simplified representations of devices or parts thereof, as involved in embodiments. Similar or functionally similar elements in the figures have been allocated the same numeral references, unless otherwise indicated.

Computerized systems, methods, and computer program products embodying the present invention will now be described, by way of non-limiting examples.

### DETAILED DESCRIPTION

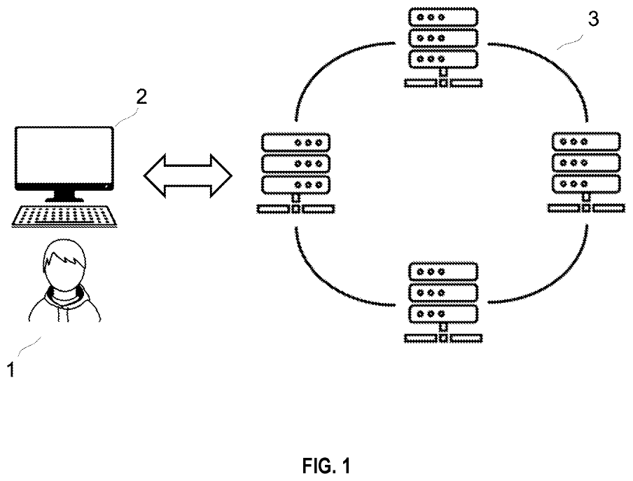

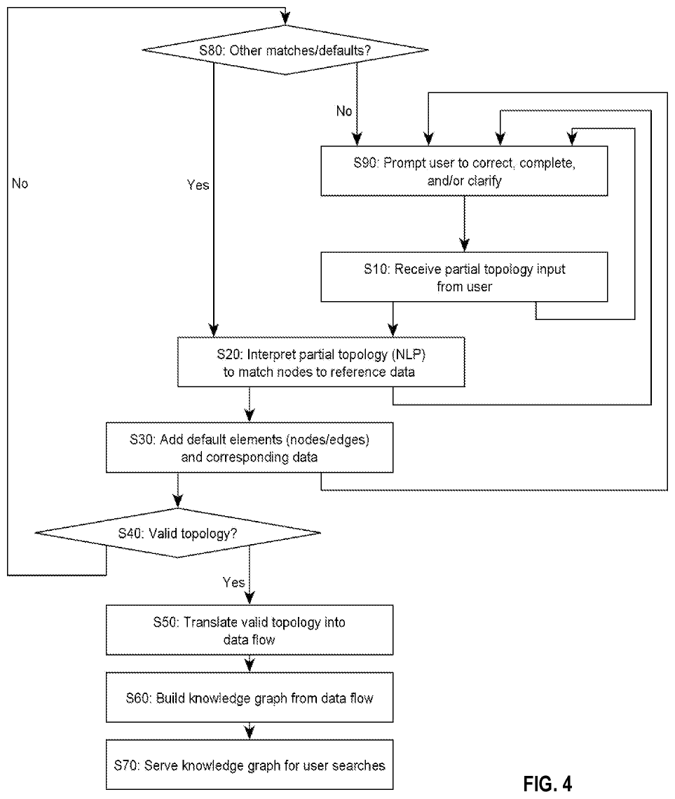

In reference to FIG. 4 and FIG. 5, a first aspect of the invention is now described in detail. This aspect concerns a computer-implemented method of building a knowledge graph. The method may for instance be implemented by a computerized system 3 such as shown in FIG. 1, i.e., a cloud computing system in this example. Note, the system 3 may also be a general-purpose computer (e.g., configured as a server) or any other type of computer. This system 3 concerns another aspect of the invention, which is described later in detail. The context assumed in FIG. 1 is one where a user 1 interacts with the system 3 via a personal computer 2, in order to build a knowledge graph (KG).

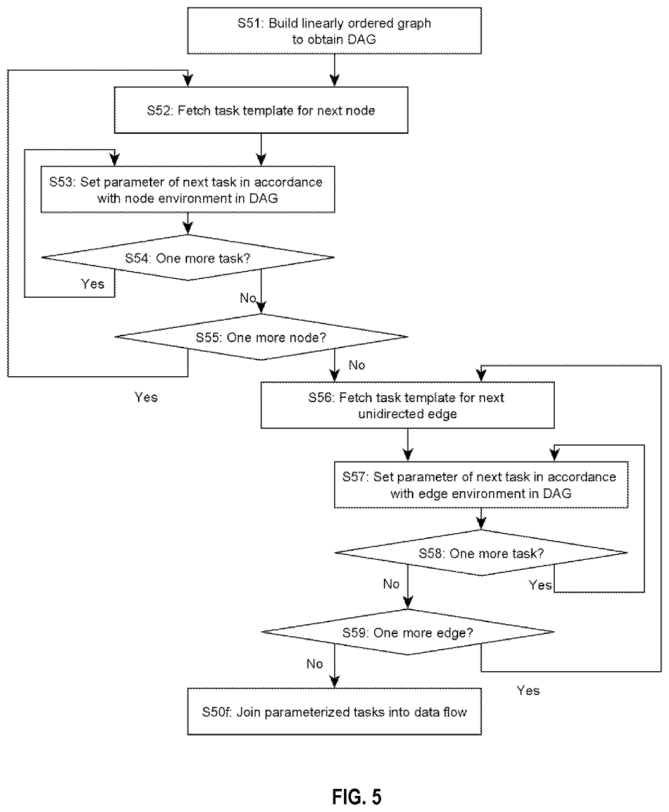

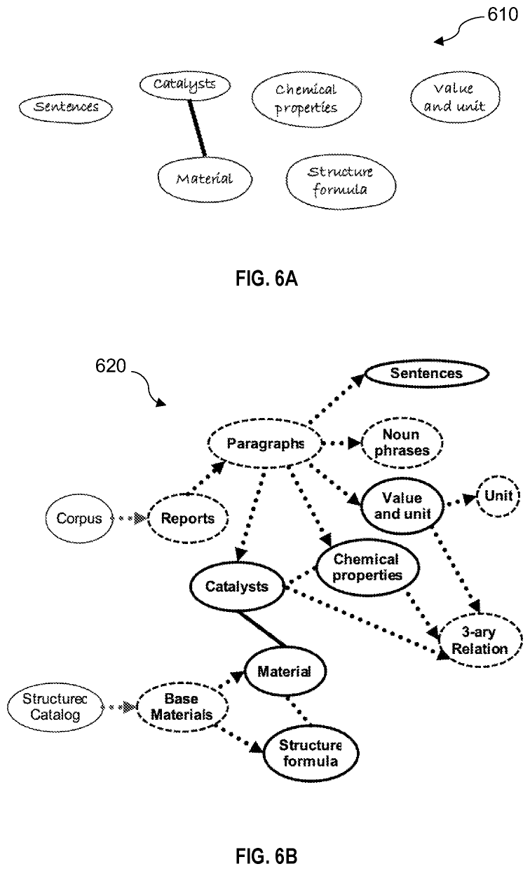

The proposed method relies on user inputs as to a partial topology of a KG that the user 1 wants to build. For instance, a user may initially provide a handmade drawing (as assumed in FIG. 6A) and/or may be assisted by a tool (i.e., a software wizard or assistant) to produce the initial topology, as in embodiments discussed later. Such inputs are converted into initial nodes, to which respective natural language descriptions are attached, as depicted in FIG. 6A. At least one initial node is needed to start the process. Note, the user input may further include one or more links, as assumed in FIG. 6A (an undirected edge in this example).

This initial topology is then interpreted (at step S20 in FIG. 4) to match against reference data. More precisely, the natural language descriptions corresponding to the initial nodes are interpreted (at step S20 in FIG. 4) using natural language processing (NLP), with a view to matching the initial nodes against the reference data.

For example, the reference data may, initially, include subsystems of an existing KG creator system (e.g., implemented at the computerized system 3) and weakly structured data. The reference data may for instance include taxonomies or dictionaries for fields of interest, existing NLP modules to extract certain types of data from natural-language texts (such as persons, organizations, locations, chemical elements, medical terminologies, etc.), as well as large corpora of documents stored in data repositories. In variants, or in addition, the reference data may also include data stored in databases. An efficient approach is to interpret (at step S20 in FIG. 4) the initial topology to match it against subsystems of the existing KG creator system. For example, if the user desires “Catalysts” (as in FIG. 6A) and an NLP model “Chemical classes” with an output class “Catalyzer” exists in the KG Creator, then “Catalyzer” should be identified as a match for “Catalysts”. This would make it possible to include this NLP model and a selection of its “Catalyzer” outputs into the dataflow, so that, when the dataflow is executed, the catalysts will be extracted from the large corpora of documents into the knowledge graph. In addition, the reference data may be subject to an attempt to structure the data, at least partly, e.g., to map the data onto one or more reference KGs. Such reference KGs can thus be used to try and match the user inputs against the reference data. However, such KGs should be distinguished from the KG to be built according to the present method.

A valid topology 620 (shown in FIG. 6B) is subsequently obtained (see steps S30, S40, and S80 in FIG. 4) based on the matched reference data. A valid topology 620 refers to a topology that has one or more root nodes, where all the other nodes are connected from the roots. The root nodes typically correspond to source data or, at least, a variable for the source data, it being noted that the actual source data can be inputted and processed later. Child nodes of this topology are, mostly, hierarchically connected from the root nodes to form a hierarchy. Still, undirected edges may also be present (as assumed in FIG. 6B, as a result of the user inputs shown in FIG. 6A). Undirected edges allow some flexibility in the node processing, as discussed later in detail. In variants, this topology may possibly be obtained as a directed acyclic graph (DAG). More generally, the valid topology 620 may be also formed as an undirected graph, a linked list, or any other suitable data structure.

In the present case, the nodes and edges of the valid topology 620 are mapped onto the matched reference data thanks to associations, i.e., relations that links the topology elements to respective matched data. Note, such associations are conceptually distinct from the topology of nodes and edges. Nevertheless, these associations are closely related to the nodes and edges of the topology, owing to the mapping performed. As a result, an initial word, or group of words, as initially provided by the user (e.g., the word “catalyst”) may be matched with an entity class (e.g., “Catalysts”), e.g., using an NLP extractor run on given chemical classes. Such mapping is preferably extended by inserting default nodes and/or edges, and/or by prompting the user to insert additional nodes and/or edges in the initial, partial topology, as explained later in detail.

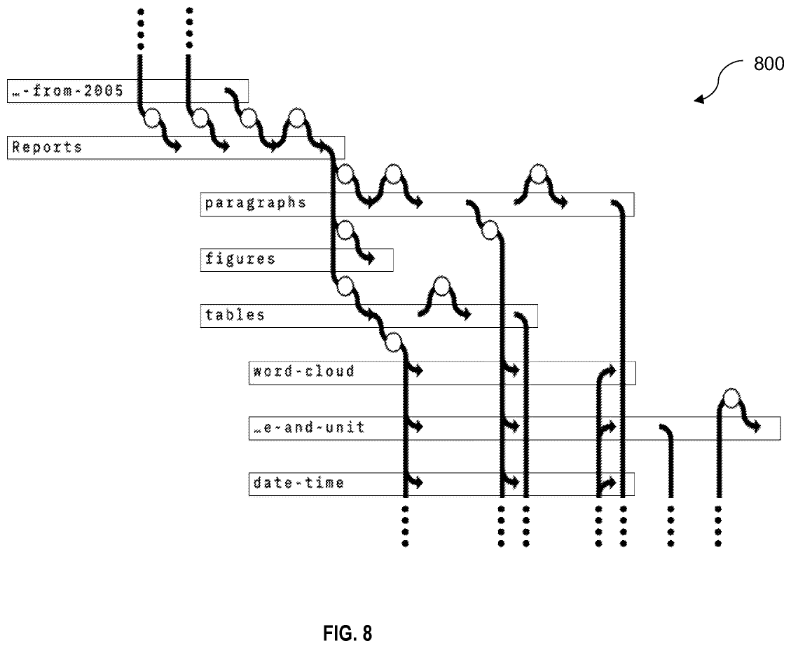

A data flow is then generated (steps S50 in FIG. 4, steps S52-S50f in FIG. 5) based on the valid topology 620 as previously obtained. This data flow links to the matched reference data, thanks to the above associations. As usual, the data flow obtained involves a network 800 of computerized tasks, which are intertwined according to a certain dependency structure, as illustrated in FIG. 8.

Finally, an executable KG is built (steps S60 in FIG. 4) from the data flow. The KG obtained is an executable object. The construction of an executable KG from a data flow is known per se. Various techniques are known to the skilled person, which allow an executable KG to be generated from a data flow. From this point on, the KG is ready for use and the system 3 will typically serve (steps S70 in FIG. 4) the KG to allow the user 1 to navigate it, e.g., to search the graph.

The KG is preferably executed in-memory, by way of vector operations. That is, the KG can typically be associated with a plurality of operators, e.g., an input operator, an edge traversal operator, a node filtering operator, a node ranking operator, logical operators, and an output operator. Such operators and their operations (how they are combined and called) essentially consist of code operating on the KG, which the algorithm typically stores as a set of nodes and edges (or vector representations thereof) in memory.

The proposed approach markedly eases the construction of KGs. As noted in introduction, the present inventors have observed that many users struggle with data flows, although they often happen to have a fairly clear idea of the desired KG topology, i.e., the types of nodes and possibly the type of edges too. Thus, they are typically able to draw a partial topology or somehow formulate such a topology, all the more so if they are suitably assisted with relevant suggestions. Thus, what the present invention proposes is to take a partial KG topology (e.g., as a handwritten drawing) from the user 1 and then automatically derive the necessary data flow to construct the KG. This is achieved by matching the user inputs against reference data to accordingly construct a topology, based on which the data flow is subsequently derived to generate the KG.

All this is now described in detail, in reference to particular embodiments of the invention. To start with, the valid topology 620 is preferably obtained by first identifying a subset of nodes and edges, in accordance with the matched data (step S20). The identified subset of nodes and edges are then preferably completed by adding (step S30) default objects to this subset, e.g., by exploiting hierarchical relations in the reference data. As noted above, the topology elements are added (step S30) so as for the resulting topology to eventually form a valid topology 620 (Yes branch of S40). Note, the process used to complete the topology is preferably devised as an iterative process, as assumed in FIG. 4. That is, the converted user inputs can be iteratively matched (see steps S20-S40, and S80 in FIG. 4) against elements of the reference data to eventually obtain a set of nodes and edges forming a valid topology 620.

Default objects are objects of predefined types. Default objects may for instance include frequently-used types of objects, such as objects corresponding to “documents” (unless the user already mentioned more specific words like “articles” or “reports”), “paragraphs”, and “sentences”. Such objects typically correspond to a predefined hierarchy, although this hierarchy may only be implicit, initially. This is notably the case when the reference data consist of weakly structured data. Still, the reference data can be parsed to extract a hierarchy and, in turn, identify relevant nodes and edges to add (step S30). In variants, at least some of the initial nodes may be matched to data contained in a database. For example, the user may write “structure formula” (as in FIG. 6A), which input may be matched to a specific database entry corresponding to a column “SMILES” (a common abbreviation for “Simplified molecular-input line-entry system”) in an existing database “Base Materials”. In such a case, a default node corresponding to “Base Materials” can be added before the node corresponding to the “Structure formula”, as assumed in the example of FIG. 6B.

As noted earlier, both the initial user inputs and the valid topology 620 may include undirected edges, to allow flexibility in the node construction. For example, assume that a user wants to know the structure formula of catalysts extracted from given reports. In that case, a node “Catalysts” and a node “Materials” may be connected via an undirected edge. Where the reference data include databases, this may for instance result in matching the node “Catalysts” with a column “Material Name” of the database “Base Materials”. Thus, the resulting topology will contain a corresponding edge, which makes it possible to look up the structure formula by traversing from “Catalysts” to “Materials” to “Structure formula”. Undirected edges do not define how the nodes are constructed and can be built in the data flow any time after the nodes are extracted.

Referring now more specifically to FIG. 5, the data flow is preferably generated by first transforming (step S51) the valid topology 620 obtained into a DAG and then translating (steps S52-S50f) the DAG into a data flow. The tasks of the data flow link to the matched reference data via the associations evoked earlier. Note, typically, the valid topology 620 as previously obtained at step S40 is essentially a DAG already (i.e., a graph which is free of cycles and already captures a hierarchy), subject to potential undirected edges, as noted earlier. In variants, the valid topology 620 may already be a DAG. Thus, step S51 is optional. In cases where the valid topology 620 is not already a DAG, then it can advantageously be transformed into a DAG once all the necessary nodes and edges have been obtained, to ease the subsequent data flow construction.

The transformation (step S51) preferably includes linearly ordering (step S51) the nodes of the topology, to obtain the DAG as a graph of linearly ordered nodes. A linear order can be regarded as a list, which is free of branches. Doing so allows to write the flow as a linear sequence: one node is written before the other. The translation to a data flow can then simply be written as a sequential program. However, there is, in principle, no strict need to linearly order (step S51) nodes of the topology as different branches of the DAG can, in principle, be executed in parallel.

In all cases, the DAG can advantageously be translated into the data flow by automatically coding (steps S52-S59) tasks corresponding to the nodes and the edges of the DAG, in accordance with information extracted from the valid topology 620 and the associations used to map the topology elements. The tasks are coded consistently with the graph structure of the DAG, so as to suitably assign task dependencies of the tasks when coding them. That is, the tasks are coded in an order determined by the graph structure of the DAG. In simple implementations, the tasks can be iteratively coded following a linear order of the DAG, assuming that the later was linearly ordered at step S51 in FIG. 5. But, again, parallelization is, in principle, possible.

The coding of the tasks is preferably done in a fully automatic manner, without requiring any user input. That is, once a valid and suitably mapped topology has been obtained, the coding of the task can be performed in a fully automatic manner. In particular, the associations used to map the topology elements onto the matched reference data can be used to define parameters involved in task templates, as discussed below. In variants to fully automated approaches, the coding of the tasks may possibly be subject to an iterative process, where the user is prompted to confirm/infirm the tasks once automatically coded or to provide further inputs.

As seen in FIG. 5, the tasks can advantageously be coded (steps S52-S59) by completing task templates according to the information extracted from the valid topology 620 and the associations, e.g., by merely parameterizing the task templates. For example, the method may fetch (step S52) node task templates for each node of the DAG and then set (step S53) parameters of each of the node task templates, in accordance with the associations corresponding to preceding nodes of each node of the DAG, e.g., the immediately preceding nodes. Beyond the immediately preceding nodes, the method may further exploit the rest of the environment in the DAG, including nodes farther upstream and downstream nodes. The completion of the task templates is preferably implemented as an iterative process, as assumed in FIG. 5.

Similarly, the method may fetch (step S56) edge task templates, for each edge of the DAG, and set (step S57) parameters of each of the edge task templates in accordance with the environment of this edge in the DAG. Again, this is typically implemented as an iterative process, as seen in FIG. 5.

Eventually, the coded tasks can be joined (step S50f) to form a data flow, which step completes the translation of the DAG. Joining the tasks results in task dependencies as illustrated in FIG. 8, which shows a partial outline of an example of data flow. The circles correspond to tasks, linked across various nodes that are mapped onto various elements (“Reports”, Paragraphs”, etc.) of a given data repository, i.e., documents dating from year 2005 in this example. Note, the dependency structure of the tasks in the data flow is again a DAG, by construction.

As noted earlier, a particularly appealing aspect of the present proposed approach is that the user inputs may be handwritten. That is, the user inputs may include or result in an image of a handmade drawing of the partial topology. As illustrated in FIG. 6A, the image depicts handwritten information including text, as well as lines bounding the text, this making up nodes with enclosed information. In that case, the user inputs need be preprocessed (step S10) to extract the natural language descriptions from the handwritten information contained in the image. Various text and form recognition techniques may be used to that aim, which techniques are known to the skilled person.

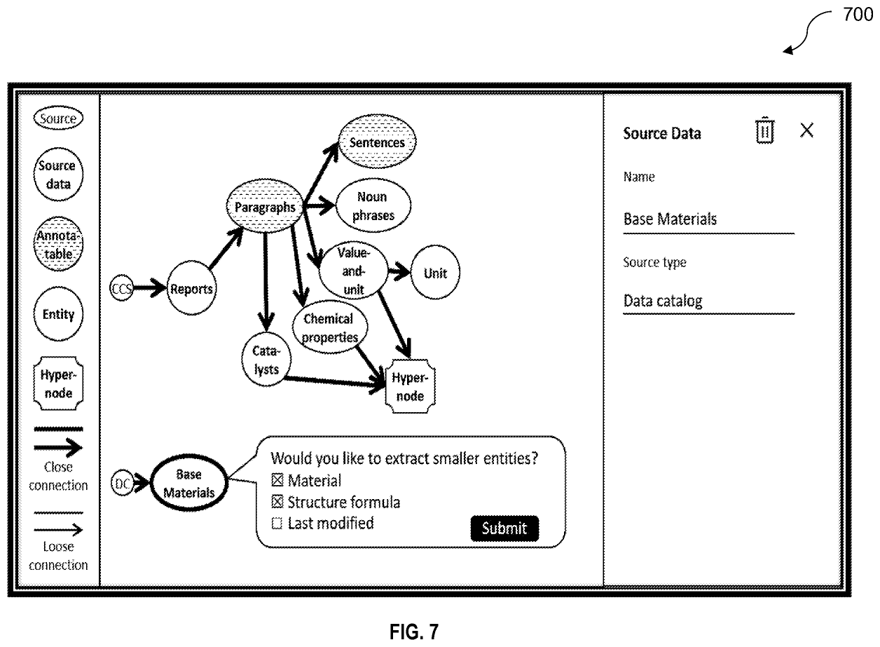

In variants, or in addition, the user may rely on usual graphical user interface (GUI) means, i.e., click actions, and selections, to input text as needed to compose the initial topology and the related descriptions. The user 1 may for instance be guided thanks to an advanced GUI tool 700, as assumed in FIG. 7. Various tools can be used to assist and guide the user 1 to formulate the initial topology, by exploiting information obtained from the reference data. As seen in FIG. 4, the user 1 may for instance be prompted (step S90) to provide further inputs (see also FIG. 7), clarify such inputs, and/or complete, infirm or confirm the topological information gathered so far. The user may notably be prompted to provide (step S90) further inputs after each of the steps S10, S20, and S30.

In particular, the user 1 may be prompted to add one or more nodes (e.g., via a pop-up menu, as in FIG. 7) and one or more edges of the partial topology and provide corresponding descriptions. Note, some natural language description may possibly be automatically preselected by exploiting information available in or extracted from the reference data. This can notably be achieved by querying the reference data based on user inputs and the corresponding descriptions. Querying the reference data may for instance cause to identify one or more elements in the reference data, where such elements are syntactically and/or semantically related to a description provided by the user. E.g., receiving a user selection of a given type of node (for example corresponding to “Base materials”) may trigger a menu inviting the user to select further nodes (for example corresponding to “Material” and “Structure formula”). This process too may be iterative. That is, further selections made by the user 1 may cause the GUI to further prompt the user to add further nodes and edges (as well as additional descriptions) to the partial topology based on previously identified elements. Additional aspects of the GUI tool are described in later paragraphs.

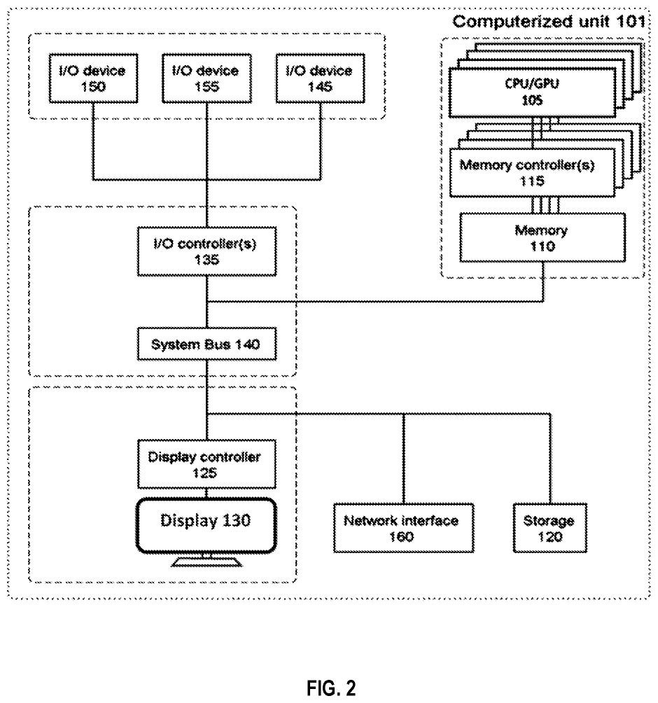

Referring more particularly to FIGS. 1-3, another aspect of the invention is now described, which concerns a computerized system 3 for building a KG. In general, the computerized system 3 may include one or more computerized units 101 such as shown in FIG. 2. In particular, and as noted earlier, the computerized system 3 may be a network of interconnected computerized units 101, e.g., forming a cloud computing system. In that case, the nodes of the computerized system 3 may store and deploy resources, so as to provide cloud services for users 1, which may be individuals, companies, or other entities.

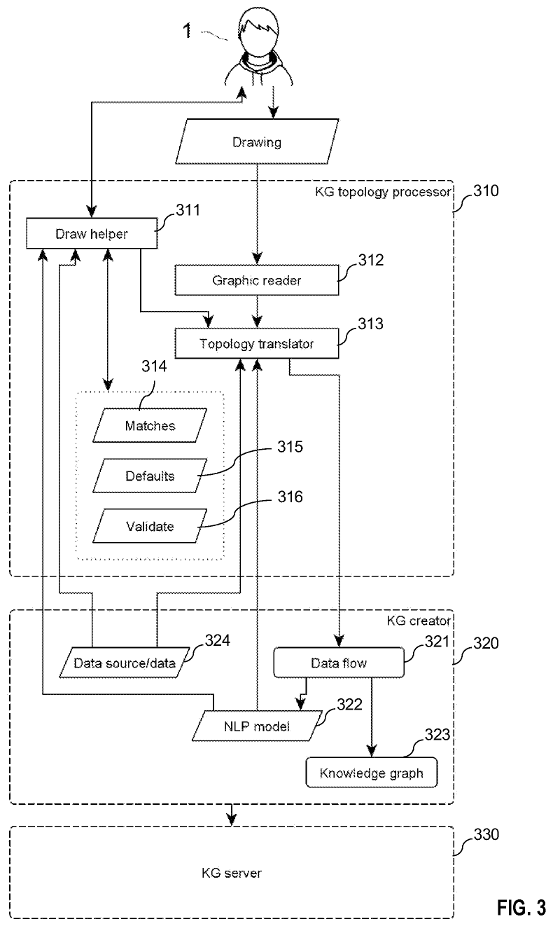

In the following, we assume that the computerized system 3 includes a single computerized units 101, for simplicity. The computerized system 3 may notably include memory 110, storage 120, etc., and communication means to communicate data to and from a personal computer 2. The computerized system 3 further comprises processing means 105. The computerized system 3 typically includes computerized methods in the form of software that is stored in the storage 120. The software instructions can be loaded in the memory 110, so as to configure the processing means 105 to perform steps according to the present methods. In operation, the processing means 105 cause the computerized system 3 to convert user inputs, interpret the corresponding descriptions using NLP to match such inputs against reference data, accordingly obtain a valid topology 620 and, in turn, a data flow linking, so as to eventually build an executable KG from the data flow. The computerized system 3 may further be configured to serve the KG in-memory, by performing vector operations, to allow the user 1 to navigate the KG, as discussed earlier in reference to the present methods. The computerized system 3 may notably be configured so as to enable modules such as depicted in FIG. 3.

Next, according to a final aspect, the invention is embodied as a computer program product for building a KG. The computer program product comprises a computer readable storage medium having program instructions embodied therewith. Such program instructions are executable by processing means 105 of a system such as described above to cause the latter to perform steps according to the present methods.

The above embodiments have been succinctly described in reference to the accompanying drawings; however, they may accommodate a number of variants. Several combinations of the above features may be contemplated. Examples are given in later paragraphs.

FIG. 4 shows a high-level flow of operations, in accordance with one embodiment of the present invention. A partial topology (with input nodes) is received as input from a user at step S10. At step S20, this partial topology is interpreted using NLP to match the received input nodes to data obtained from reference data, e.g., repositories. A reference KG may be used to that aim. Default elements (nodes and edges) and corresponding data are added at step S30. Step S40 checks whether a valid topology 620 is already available. If not (No branch of S40), the method attempts to add (step S80) further default nodes or nodes corresponding to further matches (as identified at step S20). The process then goes back to step S10, should no further node need to be inserted. However, the method loops back to step S20 as long as further nodes are found, to interpret the updated topology and match the added nodes. Note, the user may be prompted (step S90) to correct, complete, clarify, confirm and/or infirm the topology at any time after steps S10, S20, and S30. Once a valid topology 620 has been achieved (Yes branch of S40), the topology is translated (step S50) into a data flow, based on which the final KG is built (step S60). From this point on, the KG can be served (step S70) for the user to search it.

FIG. 5 shows an implementation of the translation (step S50). First, the method builds (step S51) a linearly ordered graph to obtain a DAG (optional). Next, a task template is fetched (step S52) for each node in an iterative manner, i.e., for each task (step S54) and for each node (step S55). Each task template is filled by setting (step S53) parameters thereof in accordance with the preceding nodes in the DAG. Once all tasks have been completed for each of the nodes (No branch of S54, No branch of S55), the process moves on to step S56, to start a similar iterative process for edges. Task templates are fetched (step S56) for each edge and adequately filled (step S57) by setting corresponding parameters, until no more task remain (No branch of S58) and all edges have been processed (No branch of S59). Eventually, the parameterized tasks are joined (step S50f) into a data flow.

FIG. 3 shows a functional diagram of the computerized system 3, which can be designed to run a set of interacting modules. The first module is a topology processor 310, which includes a draw helper 311 to interact with and guide a user 1 and/or a graphic reader 312 to interpret handwritten user inputs. The draw helper 311 may access data from reference data (e.g., from existing system modules 314 and 315 and from certain data sources 324) to identify potential matches and default nodes. Data pertaining to matches and default nodes are advantageously cached by the topology processor 310. A validate component 316 may be used to validate at any point in the process whether the current topology is valid. A topology translator 313 reads outputs from the draw helper 311 and the graphic reader 312 (preferably once the topology is valid) to form a data flow 321. The latter is accessed by the KG creator module 320 to build the knowledge graph (KG) 323. Typically, one or more tasks of the dataflow use an NLP sub-module. This may notably be the case in the task that builds the “Catalysts” nodes given the “Paragraphs” nodes for the topology in FIG. 6B. Following an example described in previous paragraphs, the task template for extracting concepts from text fragments may for instance be parameterized to use the “Paragraphs” nodes as text fragments, and to apply an NLP model 322 “Chemical classes” with an output class “Catalyzer” that already exists in the KG Creator 320. At KG build time, this NLP model is actually applied to all instances of “Paragraphs” (i.e., real paragraphs of the underlying documents) to extract all occurrences of catalysts in these paragraphs. In a following task, which is also parametrized by the topology translator 313 when handling the “Catalysts” node, the occurrences of catalysts are aggregated. For example, if a catalyst “Potassium hydroxide” occurs in 4 paragraphs, and its synonym “KOH” occurs in 6 more paragraphs, then only one node instance “Potassium hydroxide” of the node type “Catalysts” is constructed, but it has incoming edges from 10 paragraphs. The KG built is eventually used by a KG server module 330 to serve the KG.

FIG. 6A shows an example of a partial, handwritten topology 610 as initially provided by a user. This partial topology comprises a few nodes, as well as a unique edge (undirected) in this example. The initial nodes include, each, a natural language description, here corresponding to “Sentences”, “Catalysts”, “Material”, “Chemical properties”, as well as “Value and unit”. The node “Material” is linked to the node “Catalysts”, as per the user drawings.

As shown in FIG. 6B, a valid topology 620 can be constructed from such inputs, by discovering and adding new nodes (dashed circles) and suitably linking (dashed arrows) the resulting nodes. Default nodes (such as “Paragraphs” and “Noun phrases”) are added, while other nodes (such as “Reports” and “Corpus”) are discovered by exploiting a hierarchical structure of the reference data, e.g., data stored in data repositories. The hierarchical structure of the reference is typically obtained by parsing the data repositories. For each document of same source, a nested collection of text element objects can be generated, which represent the structure of the natural language text of this document (including the grammatical structure, to go down to sentences of documents), thanks to methods known per se. Note, the hierarchical structure of the reference data may already be captured as a DAG or a KG. Thus, starting from the user inputs shown in FIG. 5A, a valid topology 620 is generated, which include source nodes, like “Corpus”, linking to “Reports”, “Paragraphs”, “Sentences”, “Noun phrases”, “Value and unit”, “Unit”, “Catalysts”, “Chemical properties”, and “3-ary Relation”. Similarly, the source node “Structure catalog” links to “Base material”, “Material”, and “Structure formula”. “Material” is still linked to “Catalysts” as per the user input edge of FIG. 5A.

FIG. 7 shows an example of graphical user interface (GUI) of a tool assisting the user to formulate a partial topology. Various icons can be selected by the user on the left-hand side to input edges and nodes in accordance with the type of nodes (e.g., “Source”, “Source data”, etc.). That is, the GUI allows the user 1 to select a data source, data in this data source, as well as relations. As further seen in FIG. 7, the GUI may prompt the user to add further nodes, by displaying a pop-up window, e.g., asking whether the user wishes to extract smaller entities after having entered a node corresponding to “Base Materials”. Here the GUI makes use of the reference data where, in this example, “Base Materials” is a database with columns “Material” and “Structure formula”. In turn, the user may select corresponding entities, here corresponding to “Material” and “Structure formula”. Several types of edges may similarly be selected and annotated.

In this example the GUI further allows the user to enter a “Hypernode”. In this embodiment, “Hypernode” is a representation of relations that are more than binary. A hypernode instance represents a relation instance, and edges link it to the related concepts. For example, a 3-ary relation in the chemical area relates materials, chemical properties, and values and units, with instances like (iron, density, 7.874 g/cm3). This concept may not be initially known the user. Hence the draw helper 311 may have a rule ensuring that if there is a node “Value and unit”, a node with a subtype of “Property” (e.g., “Chemical properties”), and a node with a subtype of “Materials” (e.g., “Catalysts”, where the subtype relation is according to given taxonomies), then the GUI may suggest the user to add such a hypernode. The topology translator 313 will then add a task to the dataflow that will construct hypernode instances for instances of “Catalysts”, “Chemical properties”, and “Values and units” that were closely related in the text. For this, a specific NLP module may be provided (in the existing KG creator system), which uses the grammar of sentences stating such relations. In variants, a simpler and coarser module may be provided, which merely looks if the three instances occurred in the same sentence or paragraph. If there is more than one such option, the GUI may ask the user to select a coarser option (possibly finding wrong relations) or a finer option (possibly missing true relations).

The GUI displays metadata on the right-hand side. It may further include various other typical GUI elements, such as widgets (not shown), as usual with GUIs.

Computerized systems and devices can be suitably designed for implementing embodiments of the present invention as described herein. In that respect, it can be appreciated that the methods described herein are largely non-interactive and automated. In exemplary embodiments, the methods described herein can be implemented either in an interactive, a partly-interactive, or a non-interactive system. The methods described herein can be implemented in software, hardware, or a combination thereof. In exemplary embodiments, the methods proposed herein are implemented in software, as an executable program, the latter executed by suitable digital processing devices. More generally, embodiments of the present invention can be implemented wherein virtual machines and/or general-purpose digital computers, such as personal computers, workstations, etc., are used.

For instance, each of the personal computer 2 and the computerized system 3 shown in FIG. 1 may comprise one or more computerized units 101 (e.g., general- or specific-purpose computers), such as shown in FIG. 2. Each computerized unit 101 may interact with other, typically similar computerized units 101, to perform steps according to the present methods.

In exemplary embodiments, in terms of hardware architecture, as shown in FIG. 2, each computerized unit 101 includes at least one processor 105, and a memory 110 coupled to a memory controller 115. Several processors (CPUs, and/or GPUs) may possibly be involved in each computerized unit 101. To that aim, each CPU/GPU may be assigned a respective memory controller, as known per se.

One or more input and/or output (I/O) devices 145, 150, and 155 (or peripherals) are communicatively coupled via a local input/output controller 135. The I/O controller 135 can be coupled to or include one or more buses and a system bus 140, as known in the art. The I/O controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processors 105 are hardware devices for executing software, including instructions such as coming as part of computerized tasks triggered by machine learning algorithms. The processors 105 can be any custom made or commercially available processor(s). In general, they may involve any type of semiconductor-based microprocessor (in the form of a microchip or chip set), or more generally any device for executing software instructions, including quantum processing devices.

The memory 110 typically includes volatile memory elements (e.g., random-access memory), and may further include nonvolatile memory elements. Moreover, the memory 110 may incorporate electronic, magnetic, optical, and/or other types of storage media.

Software in memory 110 may include one or more separate programs, each of which comprises executable instructions for implementing logical functions. In the example of FIG. 2, instructions loaded in the memory 110 may include instructions arising from the execution of the computerized methods described herein in accordance with exemplary embodiments. The memory 110 may further load a suitable operating system (OS) 111. The OS 111 essentially controls the execution of other computer programs or instructions and provides scheduling, I/O control, file and data management, memory management, and communication control and related services.

Possibly, a conventional keyboard and mouse can be coupled to the input/output controller 135. Other I/O devices may be included. The computerized unit 101 can further include a display controller 125 coupled to a display 130. The computerized unit 101 may also include a network interface or transceiver 160 for coupling to a network (not shown), to enable, in turn, data communication to/from other, external components, e.g., other computerized units.

The network transmits and receives data between a given computerized unit 101 and other computerized devices 101. The network may possibly be implemented in a wireless fashion, e.g., using wireless protocols and technologies, such as WiFi, WiMax, etc. The network may notably be a fixed wireless network, a wireless local area network (LAN), a wireless wide area network (WAN), a personal area network (PAN), a virtual private network (VPN), an intranet or other suitable network system and includes equipment for receiving and transmitting signals. Preferably though, this network should allow very fast message passing between the units.

The network can also be an IP-based network for communication between any given computerized unit 101 and any external unit, via a broadband connection. In exemplary embodiments, network can be a managed IP network administered by a service provider. Besides, the network can be a packet-switched network such as a LAN, WAN, Internet network, an Internet of things network, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure refers to embodiments involving cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

While the present invention has been described with reference to a limited number of embodiments, variants, and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant, or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims. In addition, many other variants than explicitly touched above can be contemplated.

What is claimed is:

1. A computer-implemented method of building a knowledge graph, the method comprising:
converting user inputs as to a partial topology of a knowledge graph that a user wants to build into one or more initial nodes corresponding to respective natural language descriptions;
interpreting the respective natural language descriptions using natural language processing to match the one or more initial nodes against reference data;
based on matched reference data, obtaining a valid topology of nodes and edges, wherein the nodes and edges are mapped onto the matched reference data;
based on the valid topology, generating a data flow linking to the matched reference data via associations of the nodes and edges and the matched reference data; and
building an executable knowledge graph from the data flow.

2. The computer-implemented method of claim 1, wherein the valid topology is obtained by:
identifying a subset of the nodes and edges of the valid topology, in accordance with the matched reference data; and
completing the subset by adding default objects to the subset, so as for a resulting topology to be the valid topology.

3. The computer-implemented method of claim 1, wherein converted user inputs are iteratively matched against elements of the reference data to form the nodes and edges of the valid topology.

4. The computer-implemented method of claim 1, wherein generating the data flow comprises:
transforming the valid topology into a directed acyclic graph (DAG); and
translating the DAG into the data flow linking to the matched reference data via the associations.

5. The computer-implemented method of claim 4, wherein transforming the valid topology into the DAG includes:
linearly ordering the nodes of the valid topology, so as to obtain the DAG as a graph of linearly ordered nodes connected by edges.

6. The computer-implemented method of claim 4, wherein translating the DAG into the data flow comprises:
automatically coding tasks corresponding to the nodes and the edges of the DAG, according to information extracted from the valid topology and the associations; and
wherein the tasks are coded in accordance with a structure of the DAG.

7. The computer-implemented method of claim 6, wherein the tasks are automatically coded by:
completing task templates according to the information extracted from the valid topology and the associations.

8. The computer-implemented method of claim 7, wherein the tasks are completed by:
parameterizing the task templates.

9. The computer-implemented method of claim 7, wherein completing the task templates comprises:
for each node of the DAG, fetching one or more node task templates; and
setting one or more parameters of each of the node task templates fetched in accordance with associations corresponding to one or more preceding nodes of the each node of the DAG.

10. The computer-implemented method of claim 7, wherein completing the task templates further comprises:
for each edge of the DAG, fetching one or more edge task templates; and
setting one or more parameters of each of the edge task templates fetched in accordance with an environment of said each edge in the DAG.

11. The computer-implemented method of claim 4, wherein translating the DAG into the data flow further comprises:
joining coded tasks to form the data flow.

12. The computer-implemented method of claim 1, wherein the user inputs includes an image of a handmade drawing of the partial topology, wherein the image depicts handwritten information including text as well as lines bounding the text and depicts the one or more initial nodes, and wherein converting the user inputs comprises extracting the respective natural language descriptions from the handwritten information in the image.

13. The computer-implemented method of claim 1, further comprising:
automatically guiding the user, based on the reference data for the user to formulate the user inputs as to the partial topology.

14. The computer-implemented method of claim 13, wherein guiding the user comprises:
prompting the user to add one or more nodes and one or more edges of the partial topology; and
prompting the user to provide a natural language description of added nodes and edges.

15. The computer-implemented method of claim 14, wherein guiding the user further comprises:
querying the reference data based on the natural language description provided by the user;
identifying one or more elements in the reference data, the one or more elements being syntactically and/or semantically related to the natural language description provided by the user; and
based on identified elements, prompting the user to add one or more additional nodes and/or one or more additional edges to the partial topology, as well as additional natural language descriptions of the one or more additional nodes and/or the one or more additional edges.

16. The computer-implemented method of claim 1, further comprising:
serving the knowledge graph in-memory, by performing vector operations, to allow the user to navigate the knowledge graph.

17. A computer system for building a knowledge graph, the computer system comprising one or more processors, one or more computer readable tangible storage devices, and program instructions stored on at least one of the one or more computer readable tangible storage devices for execution by at least one of the one or more processors, the program instructions executable to:
convert user inputs as to a partial topology of a knowledge graph that a user wants to build into one or more initial nodes corresponding to respective natural language descriptions;
interpret the respective natural language descriptions using natural language processing to match the one or more initial nodes against reference data;
based on matched reference data, obtain a valid topology of nodes and edges, wherein the nodes and edges are mapped onto the matched reference data;
based on the valid topology, generate a data flow linking to the matched reference data via associations of the nodes and edges and the matched reference data; and
build an executable knowledge graph from the data flow.

18. The computer system of claim 17, wherein the computer system is a cloud platform.

19. The computer system of claim 17, wherein the computer system is configured to serve the knowledge graph in-memory, by performing vector operations, to allow the user to navigate the knowledge graph.

20. A computer program product for building a knowledge graph, the computer program product comprising a computer readable storage medium having program instructions embodied therewith, the program instructions executable by one or more processors, the program instructions executable to:
convert user inputs as to a partial topology of a knowledge graph that a user wants to build into one or more initial nodes corresponding to respective natural language descriptions;
interpret the respective natural language descriptions using natural language processing to match the one or more initial nodes against reference data;
based on matched reference data, obtain a valid topology of nodes and edges, wherein the nodes and edges are mapped onto the matched reference data;
based on the valid topology, generate a data flow linking to the matched reference data via associations of the nodes and edges and the matched reference data; and
build an executable knowledge graph from the data flow.
